(19) United States
(12) Patent Application Publication
(10) Pub. No.: US 2015/0261330 A1
(43) Pub. Date: Sep. 17, 2015

(54) METHOD OF USING FINGER SURFACE AREA CHANGE ON TOUCH-SCREEN DEVICES - SIMULATING PRESSURE

(71) Applicant: LUMI STREAM INC., TORONTO (CA)

(72) Inventor: Anoush Jalali, Toronto (CA)

(73) Assignee: LUMI STREAM INC., TORONTO (CA)

(21) Appl. No.: 14/204,611

(22) Filed: Mar. 11, 2014

(51) Int. Cl. G06F 3/041

(52) U.S. Cl. CPC G06F 3/041; G06F 3/0414

(57) ABSTRACT

The present invention provides a method for adding pressure simulation for touch-screen devices, by detecting a user's finger contact surface area with the screen—instead of a regular physical screen layer pressure sensor. A finger's surface area on touch-screen devices could be used for Z-axis navigation in virtual 3D environments, manipulating digital content, creative and technical software, or used as a custom variable in any application.

### FIELD OF THE INVENTION

The present invention utilizes the surface area of a finger on touch-screen devices to navigate in virtual 3D space, manipulate digital objects and content. The surface area of a finger in contact with a touch-screen can be changed by pressing harder or lighter on the surface.

### BACKGROUND OF THE INVENTION

Pressure detection in mobile device touch-screens has usually been performed by a screen that physically depresses when finger or stylus force is detected. Manufacturing of such pressure sensitive touch-screens can add extra components, be imprecise and increases the overall weight of the device

In prior art, there are several attempts to manipulate 3D objects. US RE40,891 E discloses a type of pressure sensitive cube that can be used to move virtual objects in virtual 3D space. This device aims to provide more precise control for manipulating virtual objects in 3D space, but is not created for mobile devices or use with touch-screen technology.

US 20110115784 A1 discloses another method for the manipulation and creation of 3D objects using a touch-screen. The disclosed method requires a physical pressure sensitive touch-screen layer that responds to the force that fingers exert. This method is limited to moving 3D objects on the touch-screen and does not include other applications.

US 20080094367 A1 discloses a method for scaling an image based on the pressure applied on the touch-screen by the user. The scale of the image is changed based on the pressure and image is scaled back based on the rate at which pressure is released. This method also requires a pressure sensitive screen that responds to the force that the user's finger exerts on a pressure sensitive touch-screen. This application is limited to the scaling of images and does not describe a method for its use in 3D.

The objective of the present invention is to simulate pressure sensitivity with touch-screens on mobile devices, tablets and computers. The present invention can be applied on conventional touch-screens and uses the surface area of fingers as an indicator of the pressure that is applied. Thus, there is no need for specific pressure detection touch-screen layers on devices.

### BRIEF DESCRIPTION OF THE DRAWINGS

Embodiments herein will hereinafter be described in conjunction with the appended photos provided to illustrate and not limit the scope of claims, wherein like designations denote like elements, and in which:

FIG. 1 shows the method of using finger contact surface area detection for control;

FIG. 2 shows one embodiment of the present invention where it is used for 3D navigation;

FIG. 3 shows another embodiment of the present invention being used for drawing; and

FIG. 4 shows an embodiment of the present invention being used for interactive simulations or games.

### DETAILED DESCRIPTION OF THE PREFERED EMBODIMENTS

The present invention and the various features and detailed advantages are explained more fully with reference to the non-limiting embodiments described in the following description.

The present invention is a method for manipulating digital content and navigating 3D space using any touch-screen device. This process is accomplished by applying pressure to touch-screens; however, the touch-screen device does not need to contain a physical screen layer to detect pressure. Using existing screen technology, the surface area detects a finger that is in contact with the touch-screen. Consequently, as more touch-screen pressure is applied, there is more contact area between the finger and touch-screen.

The pressure detecting simulation system will also be used for navigating virtual 3D space, application menus, windows, maps; where movement along the Z-axis is required. In another embodiment of the present invention, this system could be used to control movement of a character in a virtual environment, where increasing the area of finger contact can lead to the character moving faster or slower in 3D environments.

Touch-screen systems work using a number of different technologies. There are resistive systems which generate a small electric current on the screen and then detect the change in the electric field when a finger makes contact with the screen. The controller software detects the exact spot where the change in electric field occurs and the software translates that information to coordinates that are to be used by the operating system. The operating system can then relay those coordinates to any software application.

The present invention could be applied in touch-screen system containing a layer that stores an electrical charge on a panel within the monitor. There are circuits that monitor the system at each corner of the screen. When a finger touches the screen some of the charge is transferred to it and the charge in the screen layer decreases and is detected by the circuits at the corners of the screen. Other touch-screen systems use several circuits placed throughout the screen in order to obtain a more precise position. The controller software calculates locations of touch based on the relative differences between the circuits and translates that information to coordinates that are to be used in the operating system. The operating system can then relay the coordinates to any software application that requires them.

The present invention could be applied in infrared grid systems that use LEDs along with photo-detectors located around edges of the screen. The LEDs are arranged in horizontal and vertical grids along the screen. When a finger makes contact with the screen, it disrupts one or several of the infrared beams. The software controller detects which beams have been disrupted and then converts that information into coordinates that can be used by the operating system which make them available for any application that requires them.

There are several methods of touch recognition hardware and software controllers. The present invention could be added to all touch-screen technologies. Some could detect the number of beams or zones crossed or contacted as an indication of pressure simulation.

The application in which the pressure detection simulation is applied can then determine its use. For example, in a drawing application, the user can select a brush size that varies with the pressure being applied. In another example, the user can select a color, or the hue of a color and have it vary with the amount of pressure applied.

The present invention uses grid technology that is available in prior touch-screen systems as a means to detect contact with the touch area. It is understood that any other technology that can determine the touch area can also be used. When a finger is in contact with the touch-screen, it is detected by a number of grid areas. As finger pressure increases, more of the finger surface area comes in contact with the touch-screen. When this happens, more areas on the grid detect contact with the finger. This information is then interpreted by the system to indicate an increase in pressure. When the finger decreases its area of contact with the touch-screen, less grid areas detect the finger's presence on the touch-screen. This information is interpreted by the system to indicate a decrease in pressure. Accordingly, the grid areas used to detect contact can consist of squares, circles or any shape that can be suited to fit the touch-screen.

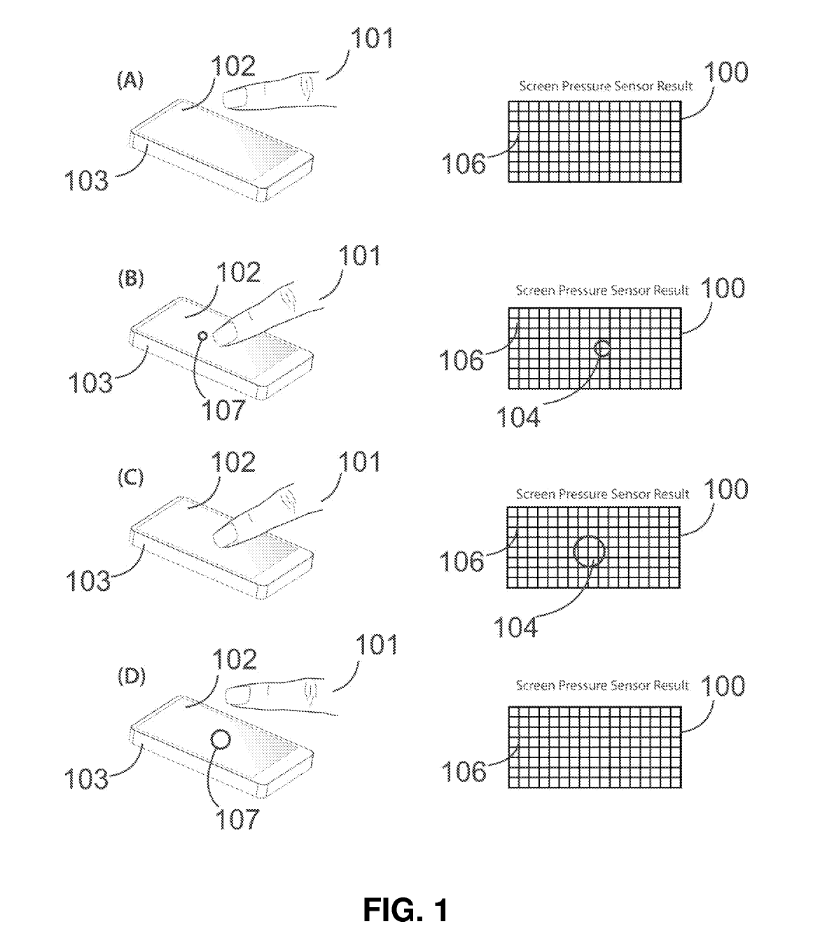

FIG. 1 shows an example of how the present invention functions with the addition of hover recognition used in some systems. In FIG. 1A a finger 101 is shown hovering above the screen and there is no contact made with the touch-screen 102 of a mobile device 103.

Based on the distance between a finger 101 which hovers above a touch-screen 102 (without touching it), the offset pointer design displays and exhibits different behaviour. By monitoring the pointer 107, the user can find out the exact location of the target area on the touch-screen 102 and adjust their finger(s) 101 before making contact—achieving perfect accuracy.

When the finger 101 is away from the touch-screen 102, no pointer is visible. The operational distance between finger 101 and touch-screen 102 can be determined by software. The distance between the finger 101 and touch-screen 102 should be at a predefined distance to be detected by sensors of the touch-screen device 104. As shown in FIG. 1B, when finger 11 gets closer to the screen 102, an offset pointer 107 starts fading in and when finger 11 gets even closer to the screen 102, the pointer 107 gets solid and smaller as shown. This is the exact location of the pointer on the touch-screen 102 and the user can make sure that the targeted area is selected correctly as shown in FIG. 1B. When contact is made with screen 102, the pointer 107 could disappear as shown in FIG. 1C, and when the finger 101 gets away from screen again 102, the offset pointer 107 re-appears as shown in FIG. 1 D. When the finger is lifted further away from the touch-screen, the cursor 107 could fade away—this prevents obstruction of the screen.

FIG. 1B shows that when a light touch is made, the contact area 104 between the touch-screen 102 and the user's finger 101 is small in area. The sensor 100 recognizes the small contact area 104 as a light touch. When more pressure is applied with a finger 101 on the contact area 104 of the touch-screen 102, the surface area detection is naturally increased, as shown in FIG. 1C. The grid 106 on the touch-screen 102 is able to detect that the area of contact 104 has increased. The surface area sensor 100 recognizes the increase in contact area 104 as more pressure being applied. When the finger 101 is no longer in contact with the touch-screen 102 the sensor 100 does not register any contact as is shown in FIG. 1D.

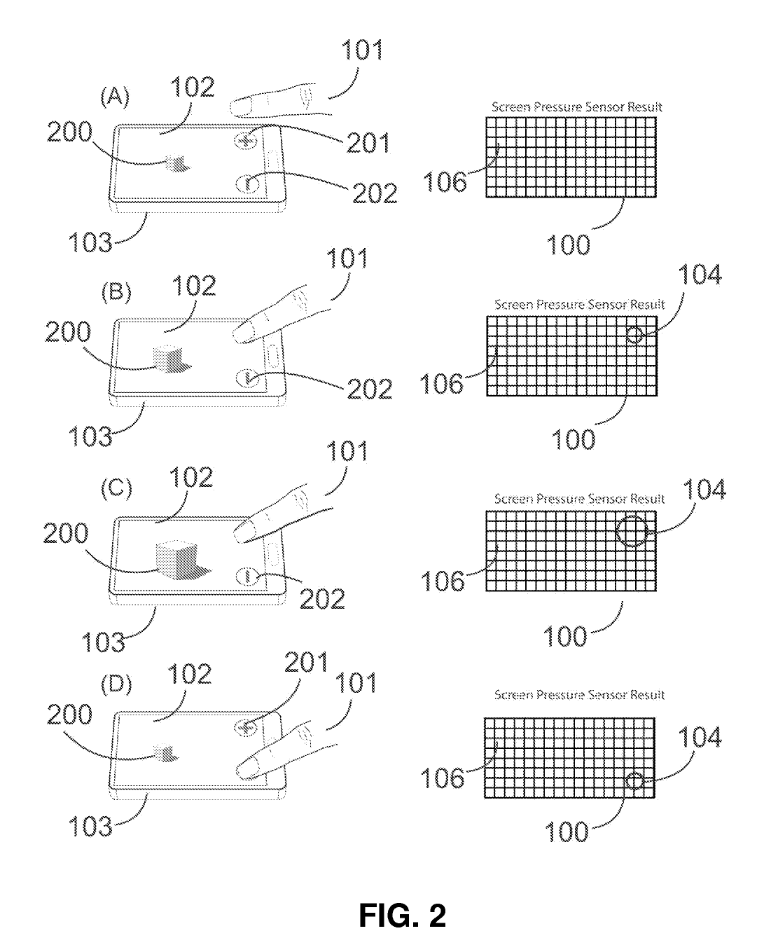

FIG. 2 is an example of 3D navigation used by the present invention. In this system, zooming in and out is performed using the zoom in 201 and zoom out 202 buttons. As shown in FIG. 1, when the user's finger 101 is not in contact with the screen, the sensor 100 does not record a reading. As the user's finger 101 comes into contact with the plus button 201 on the touch-screen 102, zooming in on the object 200 begins, as shown in FIG. 2B.

In FIG. 2C, as the user applies more pressure, the finger's 101 area of contact 104 with the touch-screen 102 increases. The sensor 100 interprets the increased area of contact 104 as more pressure being applied by the user on the touch-screen 102. When more pressure is applied to the plus button 201, the system increases the rate at which the view moves in on the object 200. As shown in FIG. 2C, the system operates in an identical manner with the minus button 202. The sensor 100 detects the finger 101 and based on the size of the area of contact 104 adjusts the zoom out speed accordingly.

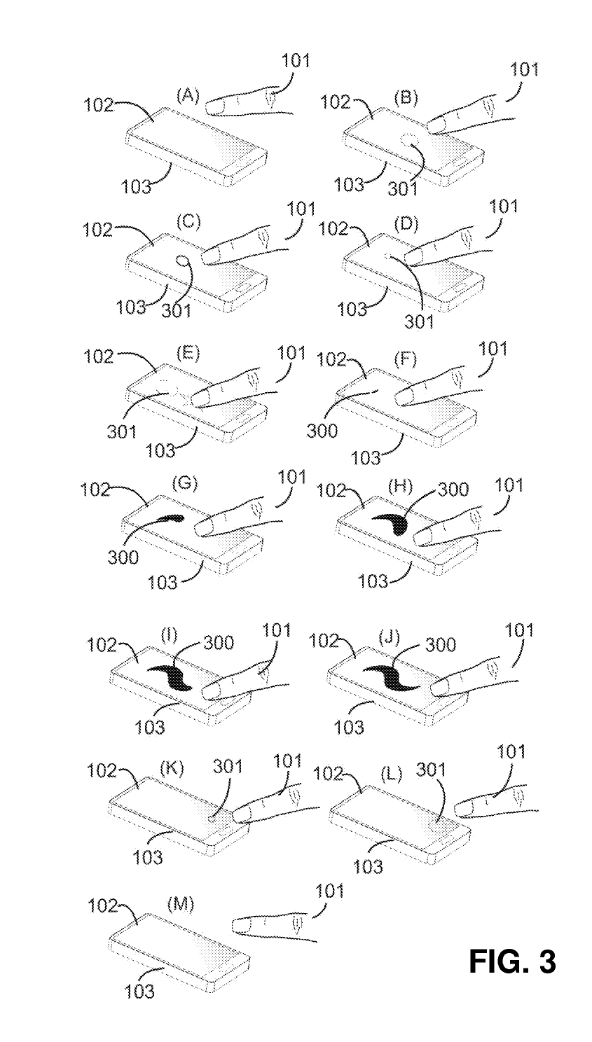

FIG. 3 shows one embodiment of the present invention with hover recognition being used in a drawing application. In this embodiment, a virtual brush can respond to the applied pressure by measuring the surface contact area between the user's finger 101 and the touch-screen 102. Prior to contact being made with the touch-screen 102 of the mobile device 103 and the finger 101 being outside of the detection range for hover detection, no data is recorded on the mobile device, as shown FIG. 3A.

As the finger 101 approaches the touch-screen 102, shown in FIG. 3B to 3D, the cursor 301 decreases in size and becomes offset in order to provide increased accuracy for the user. When the finger 101 makes contact with the touch-screen 102, the offset pointer 301 could disappear—to prevent obstruction.

FIG. 3F shows a light touch with minimal contact area between the touch-screen 102 and finger 101, causing a narrow and light line 300 to be drawn. As more pressure is applied, and the area of contact between the user's finger 101 and the touch-screen 102 increases, the thickness of the drawn line 300, as shown in FIGS. 3G and 3H. In other embodiments, the darkness, hue and saturation of the drawn line 300 could also be altered in proportion to the increased area of contact.

FIGS. 3I and 3J show the area of contact 104 between the finger 101 and the touch-screen 102 decreasing. When less pressure is applied, and thus the area of contact between the finger 101 and the touch-screen 102 decreases, the drawn line 300 becomes thinner and in some embodiments gradually transparent.

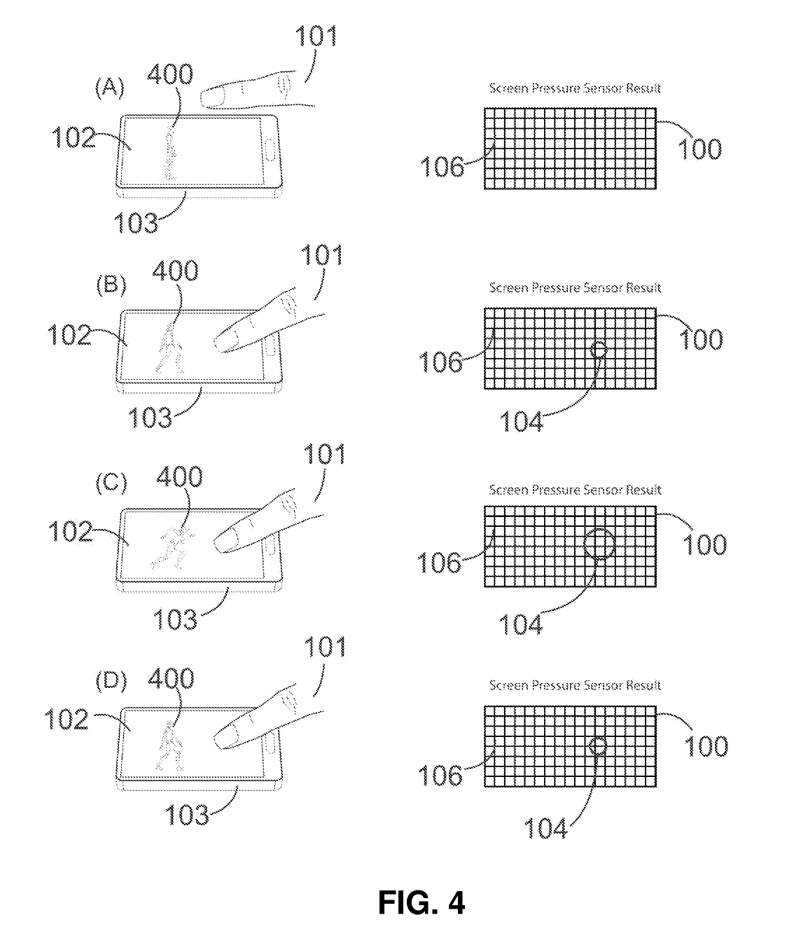

FIG. 4A shows an embodiment of the present invention that can be used in a virtual simulation. In this example, the present invention is used to control the movement of a character 400 in a simulation on a mobile device 103. FIG. 4B shows that when making contact with the touch-screen 102, the character 400 moves at walking speed. When finger pressure is light, the contact area 104 between the finger 101 and touch-screen 102 is relatively small. When more pressure is applied, the sensor grid 100 detects an increase in contact surface area 104 on the touch-screen 102 and increases the walking speed of the character 400 in proportion to the increase in the area of contact 104, as shown in FIG. 4C. When the area of contact 104 decreases again, as in FIG. 4D, the sensor 100 detects the decrease in surface contact area 104 and can proportionally decrease the moving speed of the character 400 in relation to the decrease in contact area 104.

The present invention allows for the change in contact area to be used to provide more precise inputs in a variety of applications. A finger contacting a conventional touch-screen without surface area sensitivity is only able to provide two types of data. For example, no contact between a conventional touch-screen and a finger can be interpreted as a 0 signal and contact between a conventional touch-screen and finger can be interpreted as a 1 signal. With conventional touch-screens that do not have surface area detection, there does not exist a method for generating values between 0 and 1, or ON and OFF.

The present invention allows for more precise input, by using the area of contact between the finger and the touch-screen. As previously, when there is no contact between the finger and the touch-screen, the system interprets this as a value of 0. When contact between the finger and touch-screen begins, the value can increase in proportion to the area of contact. This allows for values between 0 and 1, or any other defined lower and upper boundaries, to be selected.

The foregoing is considered as illustrating only principles of the invention. Further, since numerous modifications to the present invention could be made by those that have an understanding of this system, it is not desired to limit the invention to the exact construction and operation shown and described, and accordingly, all suitable modifications and equivalents may be resorted to falling within the scope of the invention.

With respect to the above description, it is to be realized that the optimum relationship for parts of the invention with regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed:

1. A method for navigating and manipulating virtual 3D space and objects in a touch-screen device using the area of contact between a finger and touch-screen comprising the following:
a. touching the touch-screen with a finger;
b. determining the area of contact between the figure and the touch-screen using a sensor means;
c. changing the area of contact by pressing and depressing the finger on the touch-screen; and
d. converting a change in the area of contact to a functional parameter, wherein said functional parameter being defined by a user in a preferred application.

2. The method of claim 1, wherein said functional parameter being a change in a numerical value, whereby the increase or decrease of said numerical value displayed on said touch-screen is increased and decreased by pressing and depressing, respectively, the finger on the touch-screen.

3. The method of claim 1, wherein said functional parameter applied for magnifying, whereby an object displayed on said touch-screen is zoomed in and zoomed out by pressing and depressing, respectively, the finger on the touch-screen.

4. The method of claim 1, wherein said functional parameter being the rate of change in magnification of an object displayed on said touch-screen.

5. The method of claim 1, wherein said functional parameter being the thickness of a brush displayed on said touch-screen device application, whereby the thickness of a brush in a drawing application is increased and decreased by pressing and depressing, respectively, the finger on the touch-screen.

6. The method of claim 1, wherein said functional parameter being the speed movement of a character in a virtual environment on a touch-screen device, whereby the speed of a character displayed on said touch-screen is increased and decreased by pressing and depressing, respectively, the finger on the touch-screen.

7. The method of claim 1, wherein said functional parameter being darkness and lightness of a digital brush line displayed on said touch-screen, whereby the darkness and lightness of an object displayed on said touch-screen is increased and decreased by pressing or depressing, respectively, the finger on the touch-screen.

8. The method of claim 1, wherein said functional parameter being hue or saturation of a color displayed on said touch-screen device, whereby the hue or saturation of an object displayed on said touch-screen is increased and decreased by pressing and depressing, respectively, the finger on the touch-screen.

9. The method of claim 1, wherein said sensor means being a touch-screen grid having a square, rectangle, triangle, circle, or polygon shape.

10. Method of claim 1, the touch-screen could use infrared technology, wherein the number of beams altered indicate a finger's contact surface area.

11. Method of claim 1, the touch-screen could use grid technology, wherein the number of zones crossed or contacted indicate a finger's contact surface area.
